(19) United States
(12) Patent Application Publication
(10) Pub. No.: US 2011/0074336 A1
(43) Pub. Date: Mar. 31, 2011

(54) APPARATUS WITH A CAPACITIVE CERAMIC-BASED ELECTRICAL ENERGY STORAGE UNIT (EESU) WITH ON-BOARD ELECTRICAL ENERGY GENERATION AND WITH INTERFACE FOR EXTERNAL ELECTRICAL ENERGY TRANSFER

(76) Inventor: John Boyd Miller, (US)

(21) Appl. No.: 12/890,656

(22) Filed: Sep. 25, 2010

Related U.S. Application Data
(63) Continuation of application No. 61/277,466, filed on Sep. 25, 2009.

(51) Int. Cl. H02J 7/00

(52) U.S. Cl. 320/101; 320/166

(57) ABSTRACT

Within an apparatus (20), a capacitive, ceramic-based electrical energy storage unit (EESU) (100) is utilized for electrical power storage, on-board electrical energy generation (140) is capable of supplying electrical energy that can charge the EESU (100), and an external interface (130) is available through which electrical charge is transferred to or from the EESU (100).

### CROSS REFERENCE TO RELATED APPLICATIONS

This Non-Provisional Application Claims the Benefit of the Priority Date of Provisional Application No. 61/277,466 Filed Sep. 25, 2009.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to electrical energy storage, on-board electrical energy generation, and external electrical energy transfer within an apparatus, specifically, an apparatus contains a capacitive, ceramic-based electrical energy storage unit (EESU), with on-board electrical energy generation capable of charging the EESU, and with an external interface to transfer electrical energy between the EESU of the apparatus and another device.

2. Background of the Invention

Electrical power generation is currently available utilizing internal combustion engine electrical energy generation or renewable energy generation such as from a solar collector or from a wind turbine. In some cases, these devices are portable.

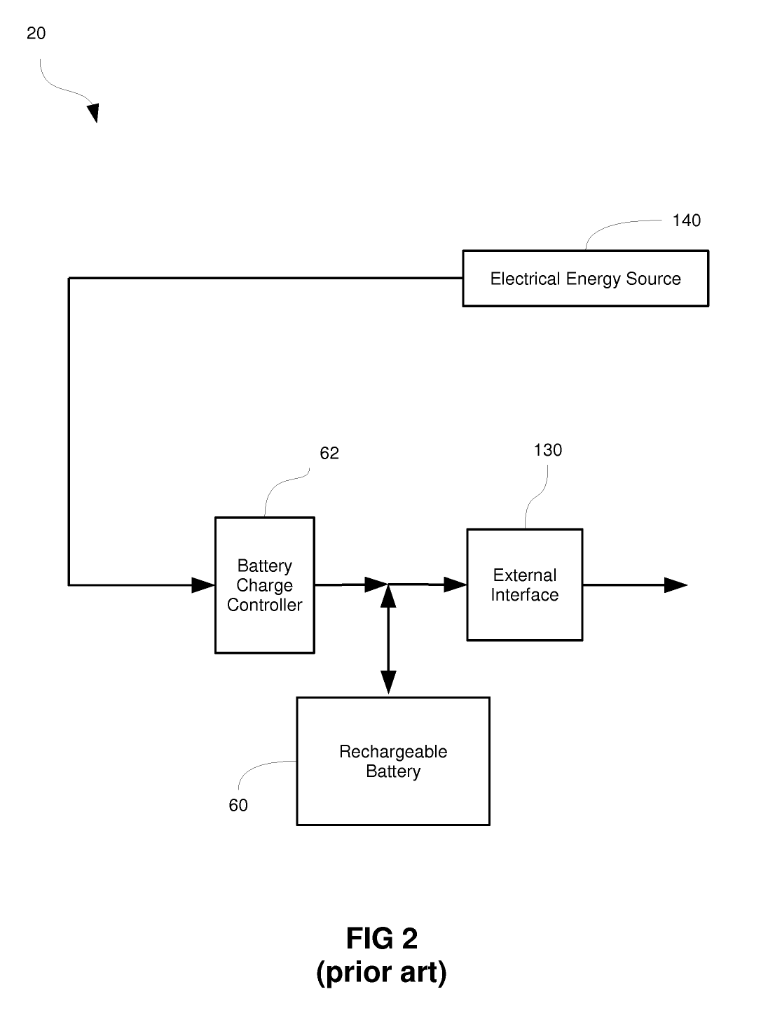

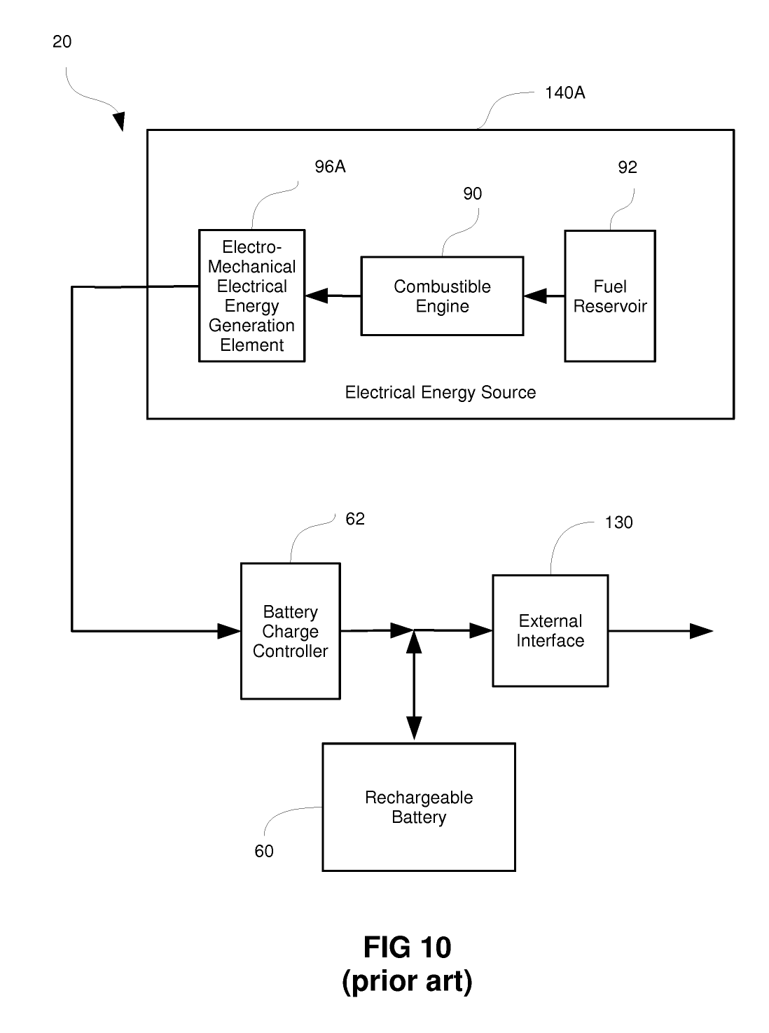

Examples of devices that provide portable and emergency electrical power generation utilizing gasoline, diesel, propane, or natural gas powered internal combustion engines FIG. 10 include portable electric generators and backup generators which provide power to homes, businesses, work sites or other locations when other sources of electric power are not available. Other devices capable of generating electrical energy that are now becoming popular are based on renewable energy and utilize solar collectors and wind turbines to generate electric energy. Generally if electrical storage is utilized with electric power generating devices such as these, batteries are the preferred storage device because of their high energy density and because batteries are readily available, FIG. 2.

Battery reliability is an issue in such devices that utilize a battery for electrical power storage in that the rechargeable batteries in such devices, while potentially lasting for many recharge cycles, eventually get to a point where they can no longer hold a charge, they become marginally useful, and ultimately they must be replaced and disposed of. The number of deep-charge cycles a battery goes through, so-called memory issues, temperature issues, shelf life issues, and other battery issues limit the useful life of most, if not all, rechargeable batteries of any chemistry make-up to less than 10 years, and in many cases to only a few years. These battery life issues within electric power backup and emergency devices create reliability issues that cause their backup or emergency availability to become questionable if not maintained and even replaced regularly. Battery life issues also severely limit or nullify the cost effective usefulness of batteries in many applications altogether because of maintenance and replacement cost issues for the user. When required, changing out batteries causes the user to incur costs in finances as well as in time. As these rechargeable batteries are disposed of, they require time, effort and cost to recycle them, or if they are not recycled, they create waste and possibly pollution and toxic waste. And battery charge times are usually on the order of hours, requiring long wait times for users between charge and discharge cycles. Full recharge times on the order of minutes are generally not available to the user.

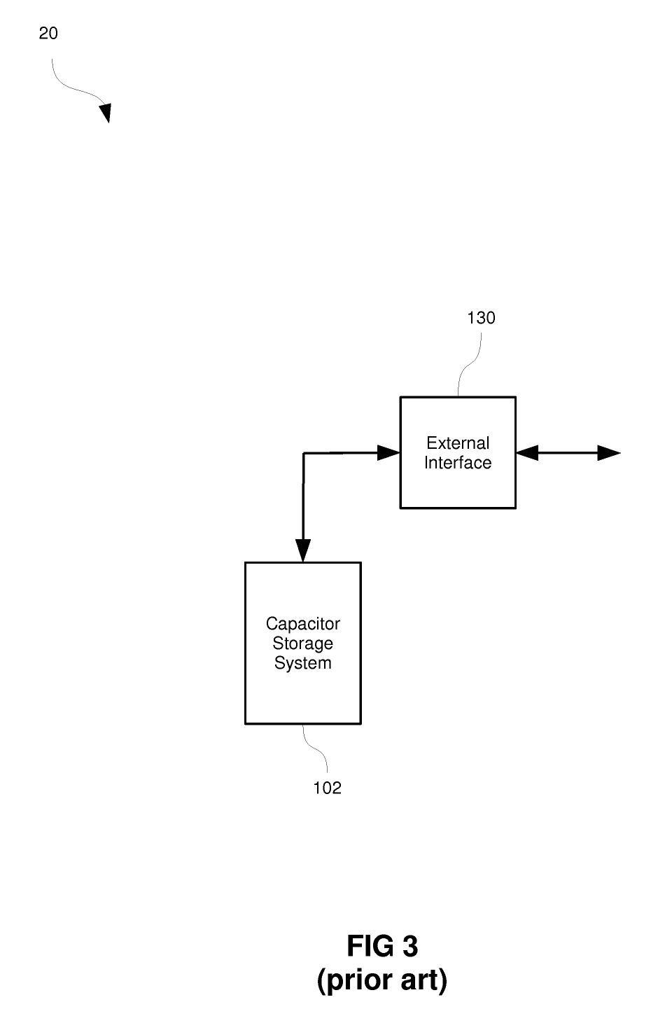

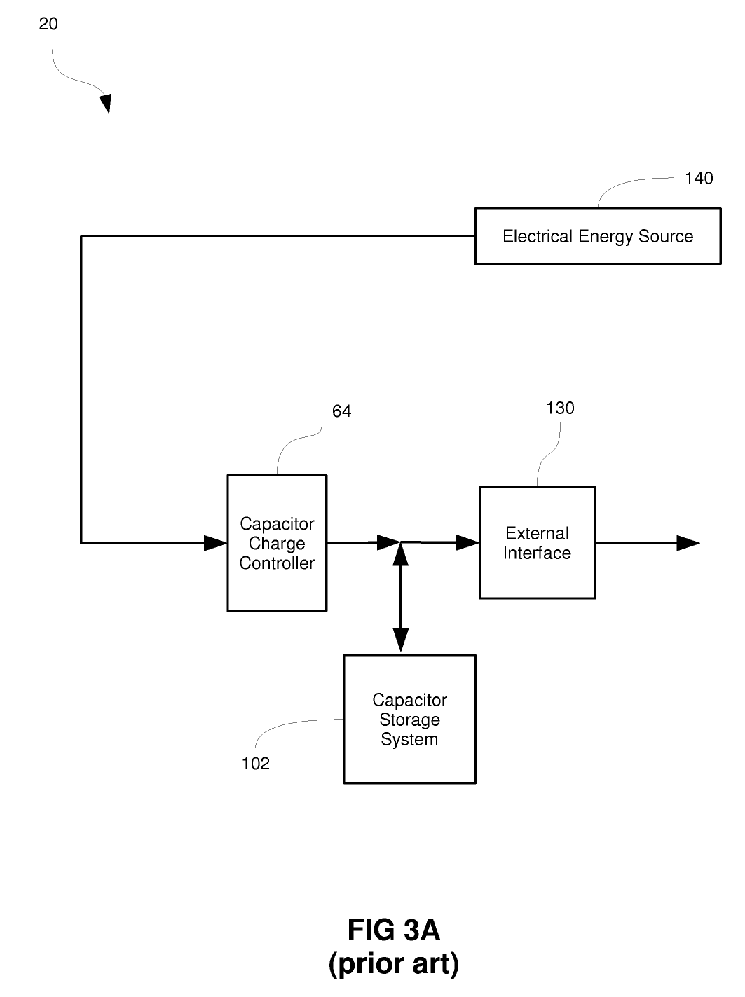

Generally fast charge and discharge capacitive based power storage devices are available FIG. 3 but their usefulness is usually in temporary storage applications. Examples of such uses are devices that are tied to the electric grid to store power for power outages or during off-peak hours, or being tied to a railway track to capture charge when a train brakes and to release charge quickly when the train starts up again. While capacitive power storage devices are generally reliable and allow hundreds of thousands of charge/discharge cycles with minimal degradation, their useable capacity tends to degrade in high temperatures, when stored for long periods with a charge, or when charged with excessive voltages, and a high self-discharge rate that is much higher than batteries contributes to capacitor devices not being utilized in environments where long-term off-line power storage is needed. Also, current supercapacitors and ultracapacitors are capable of only low energy density which therefore gives the device the characteristic of being very large, very heavy, and generally non-portable for all but applications where very low power storage capacity is required.

So while various devices by themselves perform energy generation, or energy storage, or a combination of energy generation and energy storage, a device with reliable, long-lived, fast-charging, high-density power storage and on-board energy generation is not currently available for connecting electrical power to user sites and devices for long term reliable use.

### OBJECTS AND ADVANTAGES

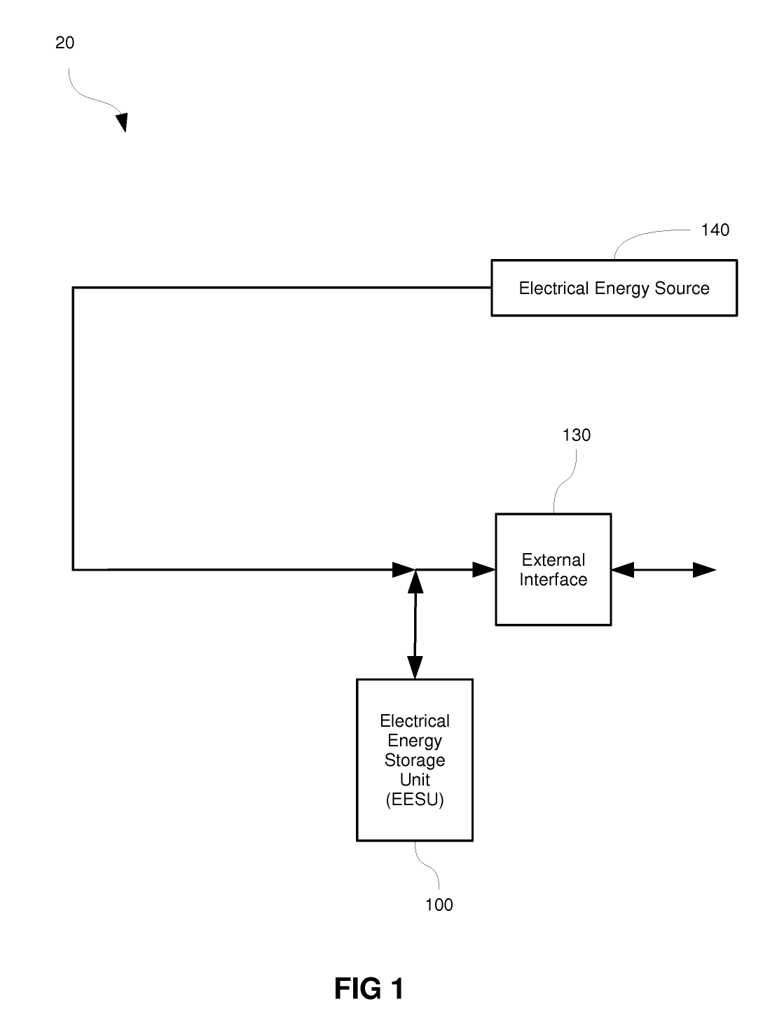

Accordingly, a solution to these issues is an apparatus with reliable, long-lived, fast-charging, high-density power storage, that includes energy generation, and that also includes an interface to an external device or site that can utilize the electrical power stored in the apparatus, FIG. 1.

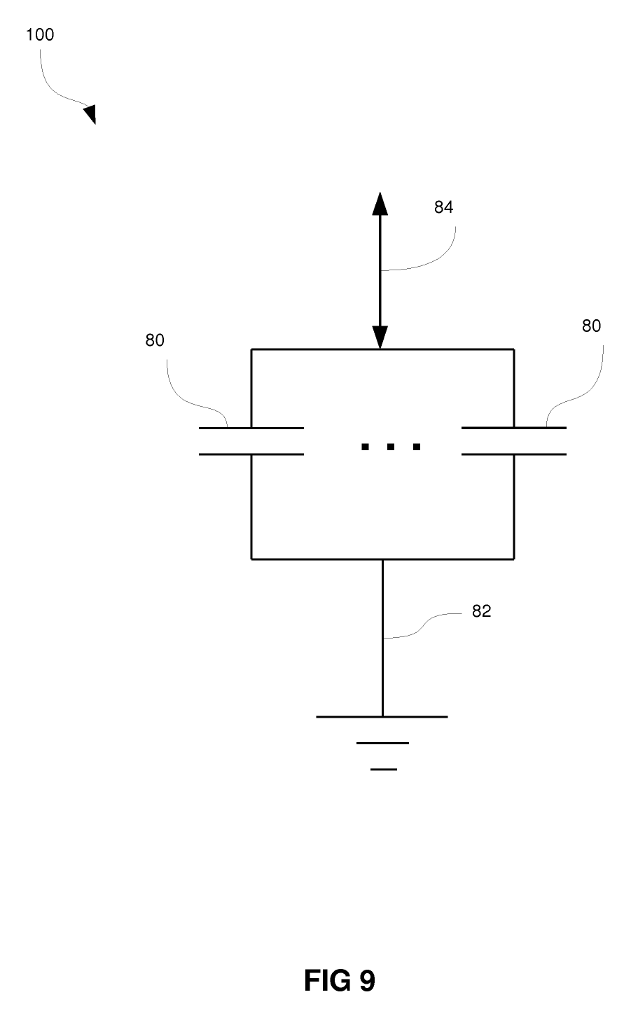

FIG. 1 shows an exemplary apparatus of the invention that utilizes an electrical energy storage unit to store energy in a rechargeable, high density, capacitive, ceramic-based electrical energy storage unit (EESU) FIG. 9 that allows recharging of the EESU from an on-board energy source, and that allows transfer of energy between the EESU of the apparatus and an external device or site through an external interface.

One element of an apparatus of this invention FIG. 1 is on-board electrical power generation. Electrical power generation on devices of this invention can come from varied sources such as solar, wind, electro-mechanical including motor feedback, man-powered such as exercise equipment built for generating electrical power, thermal, water-powered or rain-powered, acoustic, static, as well as electric generation powered by an internal combustion engine or nuclear energy, and others.

Another element of an apparatus of this invention, the external interface, can have varied functionality and can take various physical forms. For example, the external interface can be unidirectional such that electrical energy is transferred solely from the EESU within the apparatus to an external device. The external interface can also be built to be bidirectional so that the EESU within the apparatus can be pre-charged by transferring electrical energy from an external energy source through the external interface into the EESU, and then with a pre-charged EESU the apparatus can be utilized as a power source to an external device by transferring energy from the EESU through the external interface to the external device. The external interface can be built with electronics such as standard semiconductor power MOSFETs and control circuitry, or it can be as simple as an electro-mechanical switch or even a simple mechanical interface.

The other key element of an apparatus of this invention is a rechargeable, high density, capacitive, ceramic-based electrical energy storage unit (EESU) FIG. 9. An example of such a unit is the Electrical Energy Storage Unit (EESU) of Richard Dean Weir, U.S. Pat. No. 7,466,536 B1. The preferred embodiment of this referenced patent shows that integrated circuit techniques are utilized to sinter extremely high permittivity Barium Titanate crystals into a bulk ceramic substrate giving a very high-density capacitive energy storage capability. The referenced patent discusses a complete ceramic based EESU with 31,351 capacitive elements connected in parallel giving a total storage capacity of 52 kilowatt-hours (kWh) at a weight of 286 pounds. As the referenced patent states, this is enough electrical energy to power a vehicle for 300 miles. Other qualities are that the EESU of the Richard Dean Weir patent can be charged in about five minutes, self-discharges slower than batteries and therefore has a long shelf-life, and it is non-explosive, non-toxic, and non-hazardous. According to TABLE 1 of the referenced patent, this EESU gives over twice the energy density of LiIon batteries and over five times the energy density of NiMH or any other high-density chemistry-based batteries.

The above referenced Richard Dean Weir patent covers an apparatus that is in and of itself a high density, capacitive, ceramic-based electrical energy storage unit (EESU). Versions of this EESU storage system, or other similar ceramic-based electrical energy storage units, can be made into various sizes, energy capacities and operating voltages to power small or large, portable or non-portable devices of this invention.

Advantages of devices of the current invention over prior art electro-chemical battery based devices include that an apparatus of the current invention will give the user a power storage unit with a nearly unlimited lifetime of usefulness. This is due to the EESU power storage unit within the device allowing a nearly unlimited number of recharge cycles with little degradation due to the number of recharge cycles, deep charging cycles, extreme temperatures, or extreme voltages. On the other hand, batteries in battery-based devices degrade with usage and can be recharged only a limited number of times before their energy storing capabilities degrade to the point that the batteries need to be replaced. As an example, LiIon batteries as are in cell phones can be cycled only up to about 1200 times before needing replacement. Almost all other popular battery chemistries can be cycled fewer times than this before replacement is required.

Reliability is a key advantage for a device of this invention when compared to a device based on a battery. Far more reliable and therefore more cost effective devices can be built around an EESU power storage unit due to the reliability of the EESU itself. This opens up a large number of potential new uses. An example is a remote power generator with a solar collector that utilizes an EESU to store power instead of a battery. Utilizing batteries in a situation such as this may be unsuitable due to extreme temperatures, limited shelf life, and so called battery chemistry memory issues that over time can significantly diminish the amount of electric charge available for use when needed. For batteries, these issues all bring maintenance and cost issues, but more importantly they bring reliability issues that can cause the device to fail just when it is needed most. This can have the effect of rendering useless all the efforts and costs employed by a user to ensure the reliable usage of a valuable system when main power to the system goes out. Devices of this invention, however, will incur none of these negative issues and will be capable of performing without incident over extended periods of time and in harsh environments. Utilizing solar, wind, or other on-board energy generation methods will allow devices of this invention to operate reliably for extended periods without significant performance degradation over time as with battery based devices.

Charging an apparatus of this invention is accomplished by delivering electrical energy from the on-board energy-generating device to the EESU. The EESU of the apparatus can also be pre-charged from an external source through the external interface. This invention has an advantage over electro-chemical batteries during charge cycles in that this invention requires only that charge be transferred and does not require the slow process of a chemistry change and the required measured timing and overcharge safety precautions for such a process as with electro-chemical batteries. EESU charge times can therefore be dramatically faster than battery charge times allowing full charging of large capacity EESUs in only minutes as opposed to over an hour with even the fastest battery based systems. This feature alone opens the possibility for such an apparatus to be utilized for many useful and cost effective purposes where batteries would see limited use if any.

Size and weight are another advantage for an apparatus of the current invention. This is because the energy density of the EESU power storage unit in the current invention is greater than that of popular electro-chemical batteries. Thus a device of this invention with an EESU can give the user more energy storage capacity than a prior art device with a battery of comparable size and weight, again opening up many useful applications for an apparatus of this invention.

An obvious advantage of an apparatus of the current invention is that since an EESU has a nearly unlimited useful life with minimal issues created by cycling and deep cycling, shelf life, extreme temperatures, overvoltage, and overcurrent, as with chemical based batteries, costs and inconvenience associated with power storage unit replacement will be nearly eliminated, not to mention minimizing the waste and possibly the toxic waste associated with the disposal of chemical based batteries as with prior art devices. There will also be no need to utilize energy to recycle batteries when using devices of this invention.

While prior art supercapacitors or ultracapacitors are utilized in many places, mainly for temporary power storage and for power conditioning, their usefulness in prior art devices as sole energy storage elements FIG. 3A has been limited. This is due to poor long-term power storage capabilities caused by a self-discharge rate that is higher than that for batteries, and in particular it is due to their limited energy density as compared to batteries and the large overall apparatus size and weight that is realized when these capacitors and ultracapacitors are utilized for primary power storage.

As an example, while the best ultracapacitors demonstrate energy density of 6 to 60 Wh/kg, with typical commercially available power capacities being closer to 6 Wh/kg, the EESU power source of the above referenced Richard Dean Weir patent is capable of energy density of about 400 Wh/kg giving it over 6 to 60 times the energy density or about ⅙^{th} to 1/60^{th} the size and weight for a given storage capacity. For comparison, Lithium Ion (LiIon) batteries generally have energy densities from 150 to 200 Wh/kg, roughly 3 to 30 times that of ultracapacitors.

As a simple example of storage capacity within a common device, for a small vehicle to travel 300 miles, approximately 52 kilowatt-hours (kWh) of energy will be required (as shown in the above referenced Richard Dean Weir patent). A vehicle can travel this distance utilizing a 286 pound EESU power storage unit that is capable of storing 52 kWh of energy. Equivalently, to travel this distance it would take a vehicle capable of handling the size and weight of ultracapacitors weighing from over 1,000 pounds to over 10,000 pounds just for the ultracapacitor power storage, with generally available ultracapacitors weighing closer to 10,000 pounds. Conversely, putting just 286 pounds of generally available ultracapacitors with 6 Wh/kg per unit, or about 1400 Wh of electrical energy, into a small vehicle would give users an average traveling distance of approximately 8 miles, limiting the usefulness of a common vehicle. Again, for comparison, 286 pounds of LiIon batteries at 160 Wh/kg would give nearly 125 miles of travel distance.

While the current invention is not related to utilizing EESU power storage units in end-use devices such as automobiles, boats, or aircraft, it does illustrate that a power storage device of this invention with on-board electrical energy generation and an external interface can be used for backup electrical energy or electrical energy generation and can be relatively small and lightweight when compared to a similar power storage device made with prior art ultracapacitor devices, and can therefore be utilized as a carry-on energy storage device where a similar device utilizing prior art ultracapacitors shows limited usability due to its great size and weight. As an example, while adding a 1000 to 10,000 pound auxiliary power unit made with prior art ultracapacitors to an electric vehicle for emergency power may allow it to continue to operate, possibly in a limited fashion, adding this kind of weight to a small electric aircraft where this amount of energy is useful can make it so heavy that it cannot lift off the ground or fly, clearly making an auxiliary power unit utilizing prior art ultracapacitors unusable in such aircraft. Conversely, an auxiliary power unit of the current invention with a high electrical energy storage capacity and weighing only a few hundred pounds could be very useful in such an aircraft and could extend its flying range significantly. A similar case can be made for small watercraft where adding 1000 to 10000 pounds to the craft for auxiliary power storage could sink such a craft.

Also, while an ultracapacitor can experience a loss of power storing and usage capabilities during extreme conditions such as charging and discharging at high temperatures, excessive charging voltages, or even when a unit sits unused for long periods of time such as might occur in military and emergency uses, an EESU of the above referenced patent does not degrade with temperatures or overvoltages with even the highest generally available voltages (less than 5×10̂6 Volts).

The value of a power generation and storage apparatus of this invention is derived from the long term reliable and compact operation it affords users as an auxiliary power source to devices that are powered by electrical energy.

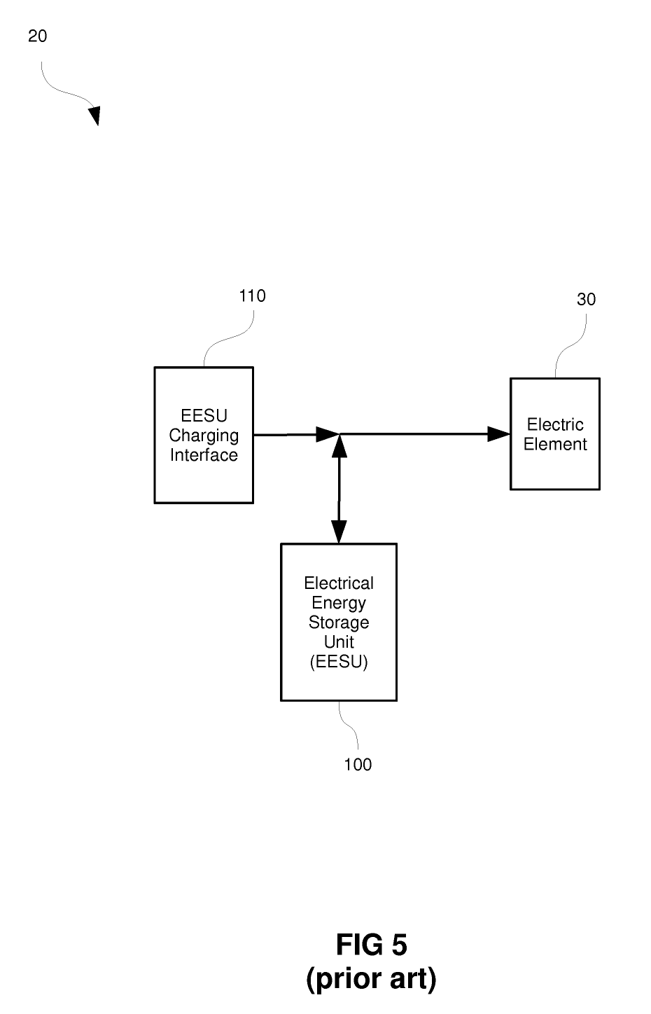

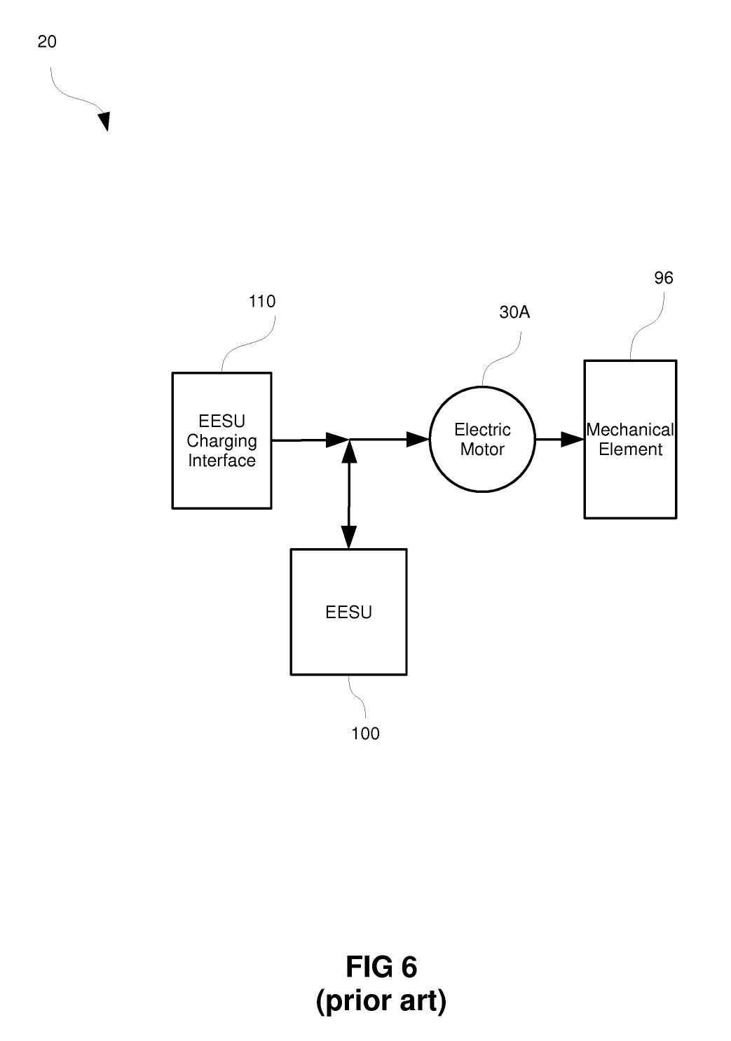

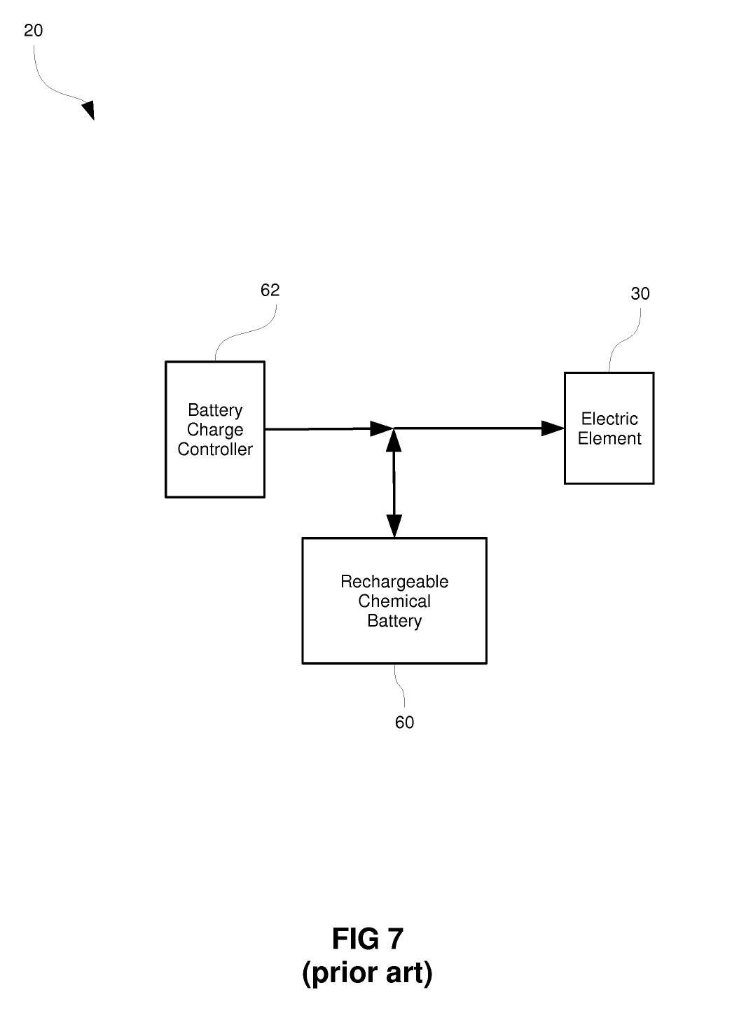

Examples of such devices are those based on an EESU and capable of connecting to external energy sources such as those of patent application John B. Miller Ser. No. 12/873,317, shown in FIGS. 5 and 6. A prior art battery-based device such as that shown in FIG. 7 can also be connected to the current invention, but electrical power transfer into the storage battery of the device would be slow due to the battery charge timing requirements of the rechargeable battery.

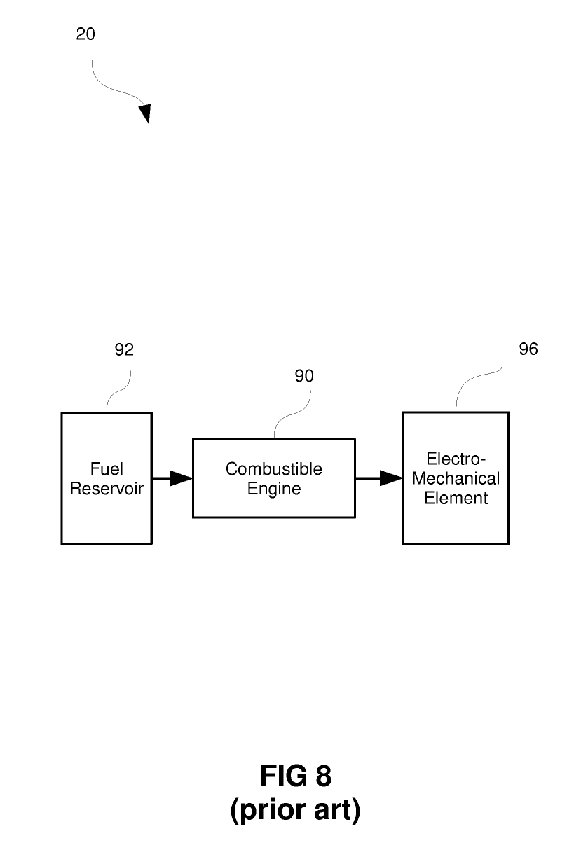

A feature of such a stand-alone power generation and storage device of this invention is that while electrical devices such as those in FIGS. 5, 6, and 7 can connect to an apparatus of this invention and can utilize its stored power and its electrical energy generating capabilities to extend their operating time, prior art devices that utilize an internal combustion engine FIG. 8 have no such options to extend their operating time. The above referenced patent application shows that vehicles such as shipping trucks, trains, and watercraft such as cargo ships and even small watercraft that utilize electric motors instead of internal combustion engines and that utilize an EESU instead of combustible fuel to power them are capable of gaining all the benefits of this invention.

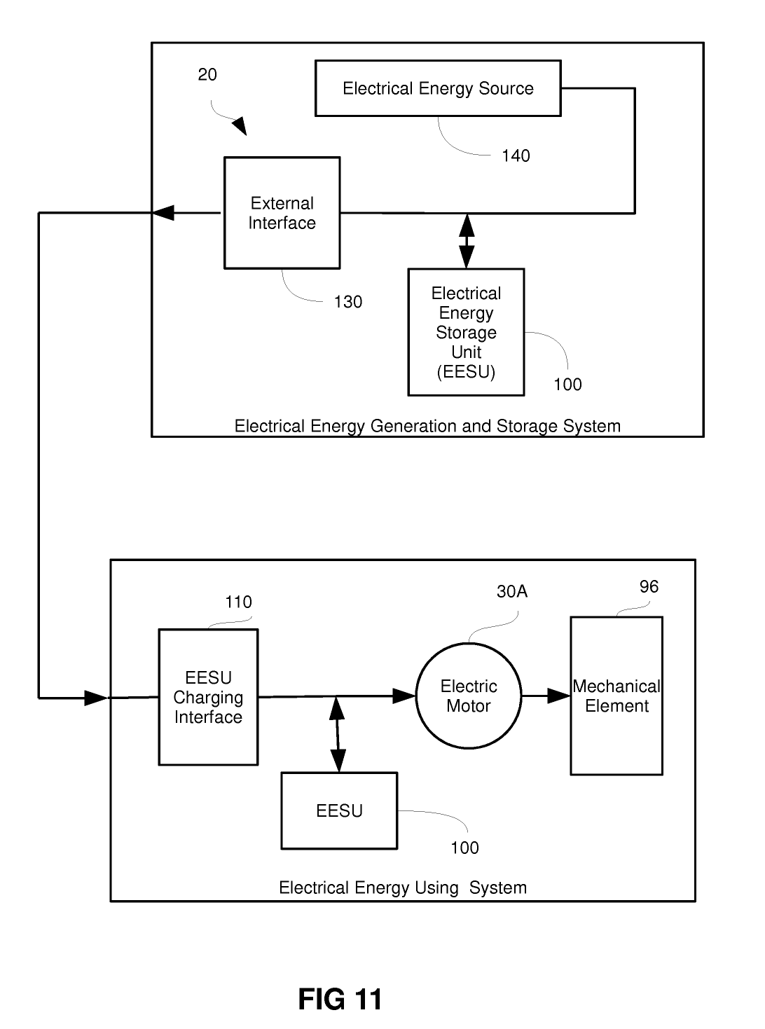

This invention can be utilized with shipping trucks, or semi-tractor-trailer rigs as they are commonly referred to, with electric motors FIG. 6 by putting, for example, large solar panels on the top of a trailer to collect solar energy and to store this electrical energy into an EESU on the trailer FIG. 1. Connecting the charged EESU on the trailer to the tractor portion of a semi-tractor-trailer that utilizes an electric motor FIG. 11 allows the semi-tractor-trailer rig to not only operate longer without stopping to recharge, but since energy is generated on the trailer itself, reduced energy costs for transporting goods with this semi-tractor-trailer combination can also be realized.

Therefore the advantages of the above referenced patent application are extended tremendously by the energy generating capabilities of an external electrical energy storage unit that can take advantage of the significant energy collection capabilities of solar panels on the top sides of large trailers and the fast energy transfer capability from the EESU on the trailer to the tractor. Energy collection via the energy generating capabilities on the trailer is not just limited to times when the trailer is connected with the tractor, but in the case of solar energy generation, energy collection takes place any time sunlight allows, even when the trailer is parked and not connected with a tractor. In other words, solar energy collection can occur every day of the year that sunlight is available. Energy collection can also occur on the trailer continuously throughout the year from wind generators, rain-water generators, or other electrical energy generating devices. This can result in the generation of many mega-watts of energy per year for each trailer, which, for the many thousands of trailers utilized in this industry, combines to allow significant energy generation capability for use in this industry. This supports a healthy trucking industry and can potentially lower costs to consumers for the transportation of goods by truck. Less pollution is also an advantage of this invention since solar and other methods for renewable energy collection are clean energy generation methods. This same apparatus can also be utilized on trains in a similar manner and for similar energy cost reductions.

Devices of this invention can also be utilized to provide portable emergency power to buildings such as hospitals or critical use buildings when storms or disasters cause main power to such buildings to fail. An exemplary situation would be to incorporate this invention into one or more trailers, pre-charge the EESU on each trailer with electric power, then deliver the trailers to the emergency site and connect them to a building's electrical input. This will provide the previously stored energy to the emergency site while normal energy sources are not available, as well as providing continuously renewable energy from the solar cells, wind turbines, rain energy generation, and other energy generation devices on the trailer(s) for as long as necessary.

Similarly, the invention can be utilized to provide power for military and remote business operations such as oil exploration where other forms of power are not available. Again, for example, utilizing one or more trailers with attached solar cells, wind turbines, rain energy generators, and even man-powered exercise equipment with electric power generation capabilities and other power generation devices, could provide previously stored energy as well as continuously renewable electric power to the site in an on-going manner to supply potentially all the electric power needs for the remote site. With enough on-site energy generation capability, very little energy, if any, would need to be brought to the site from external sources, providing energy delivery and availability convenience and cost savings to the user.

Cargo ships with large deck areas, some with over one hundred thousand square feet of deck area, can also utilize this invention to collect significant amounts of renewable energy. Attaching devices of this invention with solar collectors above the cargo containers on the ships' large deck space could collect significant energy, possibly thousands of mega-Watt-hours of renewable electric energy per year. As solar efficiencies increase, the amount of energy collected will also increase. Utilizing other renewable energy methods or a combination or renewable energy methods such as solar, wind, rainwater energy generation, and other methods will also increase the amount of renewable energy available to reduce energy costs and to reduce pollution.

Other utilization of this invention can come from smaller aircraft and watercraft that are powered by electric motor(s) and an EESU, FIG. 6, as described in the above referenced patent application. While these aircraft and watercraft may not utilize solar or other electrical energy collection methods in normal use, should they run out of their usual electrical energy reserves and otherwise be stranded, attaching the backup energy storage and collection capability of a portable device of this invention will allow the craft to recharge and continue on its journey, thus being a valuable and potentially life saving invention. Also, should a craft utilizing an electric motor and an EESU as in FIG. 6 crash, there will be no volatile fuel to explode, thus minimizing injury and increasing safety and survivability for passengers, an important feature for aircraft in particular. The energy collection and storage device of this invention can be pre-charged and safely stowed within the craft during normal use and brought out for use as needed. Note that there will be no fumes or possibility of explosion as with gasoline or other stored fuels. Again, this is a clear case where emergency energy generation capability is possible for devices that utilize an electric motor and a reliable EESU of the above referenced patent, when it is clearly not available for devices such as aircraft and watercraft that utilize an internal combustion engine.

Another example of where devices of this invention can be utilized is in homes. By collecting energy in a device of this invention by means of, for example, solar, wind, rain energy generation, and man-powered exercise equipment with electric power generation capabilities, and then connecting it to a vehicle or lawn equipment with an electric motor and an EESU, such as those of the above referenced patent application, renewable energy is utilized to quickly and reliably recharge the electrical device thus saving the user energy costs and saving the planet from extra electric power generation issues. Connecting a device of this invention to the home for emergency power usage can be realized as well. Utilizing this invention allows the user to eliminate many of the maintenance and cost issues involved with battery based energy collection and storage devices due to their high maintenance and replacement costs. It also removes many of the delivery, availability, noise, and hazard issues for the user as compared to using an internal combustion engine and the fuels and oils associated with them for on-site electric power generation.

Also, utilizing devices of this invention and prior art end use devices such as those of the above referenced patent application FIGS. 1, 5 and 6, user safety is dramatically enhanced should the device become involved in a severe accident. Since no combustible fuels are utilized with this invention, as with most vehicles and other crafts today, there is little possibly of explosion, thus enhancing safety and survivability for users. This feature could dramatically change crash death statistics in vehicles and aircraft.

As can be seen above, devices of the current invention have operational features and capabilities that are markedly different from prior art devices powered by batteries or by capacitors and ultracapacitors.

Table 1 below shows that while most batteries of various chemistry make-ups show mostly similar traits, an apparatus of this invention shows capabilities of being able to operate in different environments, with different limitations, and with different features than a battery based apparatus that performs a similar function.

In Table 2 a device of this invention can clearly be seen as useful for long-term power storage and in portable devices. This is due to ultracapacitors having a much higher self-discharge rate, and it is due to the energy density of an EESU power storage unit within a device being far greater than for an equivalent ultracapacitor power storage unit within a device. This therefore gives the potential for large electrical power storage capacity in a small overall apparatus size and weight. On the other hand, a similar device utilizing prior art ultracapacitors for power storage would be of such size and weight that its use in portable devices would be limited and could possibly be seen as changing the device from a portable device to a non-portable device, thereby changing the nature and usefulness of the device for the user completely.

TABLE 1
Operational And Functional Feature Differences: Prior Art
Battery Based Apparatus vs. Current Invention Apparatus

| A Prior Art Electric Energy Generation & | Electric Energy Generation & Storage |
|---|---|
| Storage Apparatus With Electro-Chemical | Apparatus Of This Invention |
| Battery Power Storage | With EESU Power Storage |
| Expect Unreliable Apparatus Performance | Expect The Same Reliable Apparatus |
| After A Period Of Time | Performance Indefinitely |
| Due to Battery Chemistry Degradation | No Chemistry To Degrade In EESU |
| Due to Battery Memory Effect | Minimal Memory Effect In EESU |
| Due to Battery Deep Cycling | No Issues Due To Deep Cycling In EESU |
| Expect To Change Out Apparatus Battery After | No Need To Change Out Apparatus EESU |
| A Period Of Time Due To Normal Wear | Because Of Normal Wear |
| Time And Effort Inconvenience For User | No Inconvenience To User |
| Cost For User | No Cost To User |
| For Recyclable Batteries, | Apparatus Will Generally Not Degrade To The |
| Expect To Require Time, Effort, | Point Of Requiring EESU Replacement. |
| And Cost To Recycle Battery | EESU Could Possibly Be Used Or Sold As |
| After A Period Of Time | Useful Power Storage Device |
| | Even After The Rest Of The Apparatus |
| | Is Discarded Or Replaced |
| After Apparatus Battery Is Discharged, | After Apparatus EESU Is Discharged, |
| Apparatus Is Unusable Until Battery Is | Apparatus Is Unusable Until EESU Is |
| Charged Or Changed Out | Charged Or Changed Out |
| Battery Requires Electro-Chemical | EESU Needs Only To Transfer Charge, |
| Transfer, Charges Slowly At A Measured | Charging Can Take Place In Minutes |
| Pace Over One Or More Hours To Fully | Fast Charge To Full Charge In EESU |
| Charge | Is Standard Practice, Slow Charge Is |
| Fast Charge To Full Charge Is Generally | Available |
| Not Possible With Batteries | |
| Extreme Temperatures Limit Usefulness And | Extreme Temperatures Do Not Limit |
| Reliability Of Apparatus With Battery Due To | Usefulness Of Apparatus Due To EESU |
| Battery Chemistry Issues | |

TABLE 2
Operational And Functional Feature Differences: Prior Art UltraCapacitor
Based Apparatus vs. Current Invention Apparatus

| A Prior Art Electric Energy Generation & | Electric Energy Generation & Storage |
|---|---|
| Storage Apparatus With UltraCapacitor | Apparatus Of This Invention |
| Power Storage | With EESU Power Storage |
| Apparatus capable of 10 year life with little | Apparatus capable of greater than 10 year life |
| power storage unit degradation unless used in | regardless of extreme temperatures or voltages. |
| extreme temperatures, voltages or storage | |
| situations. | |
| Size and Weight, due to limited energy density, | Size and Weight, due to high energy density, |
| restricts apparatus from being portable in all but | allows smallest and lightest apparatus |
| extreme applications. | compared to any capacitor or popular electro- |
| | chemical battery based apparatus, inviting use |
| | in all portable devices and applications. |
| Long-Term Power Storage Is Limited Due To | Long-Term Power Storage Is Not Limited Since |
| High Self-Discharge Rate and Memory Effects. | Self-Discharge Rate Is Very Low And Memory |
| | Effects Are Minimal. |

Through the comparisons shown in Tables 1 and 2 it can be seen that an apparatus of this invention has distinctively different operational capabilities and features than either a prior art battery based apparatus or a prior art capacitor or ultracapacitor based apparatus. Even hybrid vehicles with a gasoline engine, batteries, and capacitors are not only different, but include many of the differences of each prior art apparatus, a battery based apparatus and an ultracapacitor based apparatus, each with their own clear differences.

There are also differences in the charging methods of an apparatus of the current invention verses a prior art apparatus utilizing a battery as a power storage source. While a prior art battery charger can only charge to a full charge at a slow rate, generally over one hour due to the slow and carefully controlled process of chemistry change that must take place, an EESU can be charged to a full charge within minutes by simply transferring charge. And while a prior art battery charger must utilize charging algorithms to provide varying voltages and currents at different stages of the charging process to suit the particular chemistry make-up of the battery and must closely monitor conditions that could lead to overvoltage, overcurrent, and overheating, charging an EESU does not require these precautions. Even prior art capacitor and ultracapacitor charging methods must use caution to avoid allowing overvoltage lest the charge carrying capabilities and the charge releasing capabilities of the capacitor be degraded. The EESU, as described in the above referenced patent, does not exhibit these limitations for even the highest of generally available voltages.

As can readily be seen, an apparatus of the current invention utilizing an EESU such as that in the above referenced patent or a similar ceramic based energy storage device with similar qualities for power storage has a significant advantage over an apparatus designed for a similar use that utilizes a prior art electro-chemical battery as a power source. Therefore it can be easily seen by one skilled in the art that an apparatus of this invention is clearly not just another battery based device with a new type of battery that includes many of the prior art electro-chemical battery's features and limitations.

Likewise, since an apparatus of the current invention utilizing an EESU as its power source has the advantage of being able to store electrical power for long periods without significant degradation of storage capabilities, as well as having the significant advantage of allowing nearly any of the above mentioned devices to have smaller sizes and weights than current prior art devices, thus allowing many of them to be utilized in portable applications, an apparatus of this invention clearly has different features and operational capabilities than prior art devices utilizing capacitors or ultracapacitors for power storage.

As can be readily seen, a device of this invention adds for users the unique quality of reliability over similar prior art devices that utilize either batteries or capacitors making devices of this invention useable in many applications where prior art devices are either not fully useable when needed most, require excessive maintenance, or are just too costly for their limited usefulness.

Other objects of this invention and advantages of this invention will become apparent from a consideration of the ensuing description and drawings.

Thank you, Lord, for this great inspiration. Thank you Spirit of God for your guidance.

### SUMMARY

In accordance with the present invention, an apparatus includes a capacitive, ceramic-based electrical energy storage unit (EESU), on-board energy generation capable of supplying power for charging the EESU, and an external interface through which electrical charge is transferred.

### DRAWINGS

### Figures

The following description includes discussion of figures having illustrations given by way of example of implementations of embodiments of the invention. The drawings should be understood by way of example and not by way of limitation.

FIG. 1 shows an apparatus with an EESU for power storage, an electrical energy source, and an external interface through which electrical charge is transferred, according to an embodiment of the invention.

FIG. 2 shows a prior art apparatus with an electrical energy source, a rechargeable battery, a battery charge controller circuit, and an external interface.

FIG. 3 shows a prior art apparatus with a capacitive storage system and an external interface.

FIG. 3A shows a prior art apparatus with an electrical energy source, a capacitive storage system, a capacitor charge controller circuit, and an external interface.

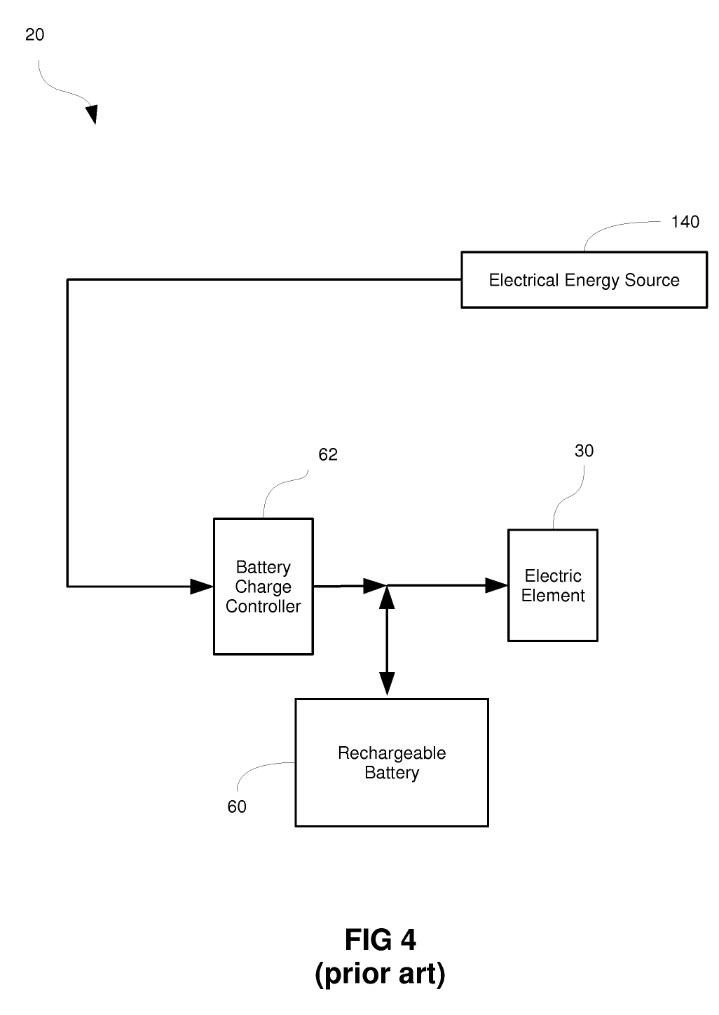

FIG. 4 shows a prior art apparatus with an electric element, a rechargeable battery, a battery charge controller circuit, and an electrical energy source.

FIG. 5 shows a prior art apparatus with an electric element, an EESU, and an EESU charging interface to an external energy source (not shown).

FIG. 6 shows a prior art apparatus with an electric motor as the electric element driving a mechanical element, an EESU, and an EESU charging interface connected to an external energy source (not shown).

FIG. 7 shows a prior art apparatus with an electric element, a rechargeable battery, and a battery charge controller circuit connected to an external energy source (not shown).

FIG. 8 shows a prior art apparatus with an internal combustion engine driving a mechanical element, and a fuel reservoir.

FIG. 9 shows an EESU with multiple capacitive elements, an Input/Output interface, and a common interface.

FIG. 10 shows a prior art power generation apparatus with an electrical energy source consisting of an internal combustion engine driving an electro-mechanical electrical energy generation element and a fuel reservoir, a rechargeable battery, a battery charge controller circuit, and an external interface.

FIG. 11 shows an electrical energy generation and storage apparatus according to an embodiment of the current invention supplying power to a prior art electrical energy using system with an electric motor driving a mechanical element.

### DRAWINGS

### Reference Numerals

20 An Apparatus
30 Electric Element
30A Electric Motor as Electric Element
60 Rechargeable Battery
62 Battery Charge Controller
64 Capacitor Charge Controller
80 EESU Capacitive Element
82 EESU Common
84 EESU Input/Output
90 Internal Combustion Engine
92 Fuel Reservoir for Internal Combustion Engine
96 Mechanical Element
96A Electro-Mechanical Electrical Energy Generation Element
100 Electrical Energy Storage Unit (EESU)
102 Capacitor Storage System
110 EESU Charging Interface
130 External Interface
140 Electrical Energy Source
140A Internal Combustion Engine Based Electrical Energy Source

### DETAILED DESCRIPTION AND OPERATION

### FIG. 1—Preferred Embodiment

An embodiment of an apparatus of the present invention is illustrated in FIG. 1. An apparatus 20 includes a capacitive, ceramic-based electrical energy storage unit (EESU) 100 to store electric power within the apparatus, an electrical energy source 140 to provide electrical energy to charge the EESU 100, and an external interface 130 through which electrical charge is transferred to or from another device (not shown).

The EESU 100, as shown in FIG. 9, is made up of multiple capacitive elements 80 connected together. As with most capacitors, one interface is utilized as a common reference 82, and the other interface is utilized as an input/output 84.

An example of an electrical energy source 140 is a solar voltaic cell, or a group thereof, such as those commonly used in calculators or emergency street-sign lighting, although any electrical energy generating source is appropriate for use in this invention, as is the use of multiple energy generating sources simultaneously.

FIG. 2 is a prior art apparatus 20 that features a rechargeable battery 60 to store charge, an electrical energy source 140 to provide electrical energy to charge the battery 60, a built-in battery charge controller 62 to charge the battery, and an external interface 130 to transfer charge to an external device (not shown).

FIG. 3 shows a prior art apparatus that uses a capacitive storage system 102 for primary storage and an external interface 130 to transfer charge to or from an external device (not shown).

FIG. 3A is a prior art apparatus 20 that features a capacitive storage system 102 to store charge, an electrical energy source 140 to provide electrical energy to charge the capacitive storage system 102, a built-in capacitor charge controller 64 to charge the capacitor, and an external interface 130 to transfer charge to and from an external device (not shown).

FIG. 4 is a prior art apparatus 20 that features an electric element 30 to provide a useful output for the user, a rechargeable battery 60 to store electrical power, an electrical energy source 140 to provide electrical energy to charge the battery 60, and a built-in battery charge controller 62 to charge the battery.

FIG. 5 is a prior art stand-alone apparatus 20 with an EESU 100 providing electric power to an electric element 30 and with an MCESS charging interface 110 to an external power source (not shown). FIG. 6 is similar in that it is a prior art stand-alone apparatus 20 with an EESU 100 providing electric power to an electric element that is an electric motor 30A, a mechanical element 96, and with an EESU charging interface 110 to an external power source (not shown).

FIG. 7 is a prior art stand-alone apparatus 20 with a rechargeable battery 60 to store electrical energy. The rechargeable battery 60 supplies electrical energy to the electric element 30. The battery charge controller 62 charges the rechargeable battery 60.

FIG. 8 is a prior art stand-alone apparatus 20 with an internal combustion engine 90 driving a mechanical element 96. The fuel reservoir 92 provides fuel to the internal combustion engine 90.

FIG. 11 is the electrical energy generation and storage unit with an external interface of the current invention as in FIG. 1 acting as an auxiliary power source for a prior art electrical apparatus as is shown in FIG. 6.

### Operation—FIGS. 1, 2, 3, 4, 5, 6, 7, 8, 11

The operation for this embodiment of this invention as shown in FIG. 1, is similar to that of the prior art apparatus 20 of FIG. 2. The EESU 100 is charged with energy from the electrical energy source 140. Transferring charge to an external device (not shown) is accomplished through the external interface 130. Generally, electrical charge is transferred from the EESU 100 through the external interface 130 to another device (not shown). In some cases, users may want to pre-charge the EESU of this apparatus by transferring electrical charge from an external source (not shown) through the external interface 130 into the EESU 100 of this apparatus for storage.

An exemplary apparatus 20 of the invention is an energy collection and storage unit mounted on a trailer that is normally pulled by a tractor to create the typical semi-tractor-trailer rig that delivers goods to stores around the country. Where most tractors currently operate with an internal combustion engine driving a mechanical element such as gears and getting its energy from a combustible fuel reservoir as in FIG. 8, in order to utilize this invention the tractor would need to operate using an electric motor with electric power as the prior art invention of patent application John B. Miller Ser. No. 12/873,317 exemplifies FIG. 6, and utilize the electrical energy generation and storage system of this invention for an auxiliary power source connected to the tractor FIG. 11 to extend the semi-tractor-trailer rig's operating range. This exemplary unit on the trailer acts as an electrical energy collection unit and also as an auxiliary power storage unit that is capable of transferring energy to or from an external device. The exemplary apparatus consists of a set of solar collector panels on the top of the trailer as the electrical energy source 140, the energy from the solar collector panels is stored into the EESU 100 as the electric power storage unit, and the external interface allows electrical energy from the EESU 100 to be transferred to the tractor for use. Optionally, the unit can be constructed in such manner that energy is pre-stored into the EESU 100 of the energy collection and storage unit 20 on the trailer from an external source (not shown) through the external interface 130 prior to being connected to the tractor. This allows the semi-tractor-trailer rig combination to carry much more electrical energy to power the tractor than the tractor can itself carry allowing the operating time of the tractor to be extended significantly.

Other applications for this same embodiment are as an emergency electric power supply for hospitals or other critical use buildings, as well as for the electric power supply for remote sites such as military or oil exploration sites. For these uses, the current invention connects to any standard building electrical inputs utilizing appropriate connections, or to prior art devices such as those in FIGS. 5 and 7. In these applications, energy previously stored into the EESU 100 of the invention from an external source (not shown) through the external interface 130, as well as energy from on-board energy generation capabilities 140, is transferred from the EESU 100 to the site through the external interface 130.

Yet another application allows the apparatus 20 of the current invention FIG. 1 to charge a prior art capacitor storage system FIG. 3 with emergency or backup energy. Charging other prior art rechargeable batteries 60 can also be accomplished by connecting a prior art stand-alone battery charger (not shown) to the external interface 130 of the current invention with proper electrical connections.

An exemplary EESU is a capacitive ceramic-based energy storage system based on the Electrical-Energy-Storage Unit (EESU) of Richard Dean Weir U.S. Pat. No. 7,466,536 B1 or a system with similar qualities, designed appropriately to fit into a trailer.

An exemplary solar collector can be made from XOB17-01x8 solar components from IXYS. A single unit gives a 4.90 Volt typical open circuit voltage output with a 4.2 miliamperes (mA) short circuit current. Utilizing multiple of these solar components in parallel or in series within an apparatus can give larger charge current capability, larger charge voltage capability, or both.

FIG. 1—Additional Embodiment

An additional embodiment of an apparatus of the present invention, as shown in FIG. 1, is backup or emergency energy storage and collection capability in a stand-alone portable device. Again, an apparatus 20 includes a capacitive ceramic-based electrical energy storage unit (EESU) 100 to store electrical energy within the apparatus 20, an electrical energy source 140 to provide electrical energy to charge the EESU 100, and an external interface 130 through which electrical charge is transferred to or from an external device.

The EESU 100, as shown in FIG. 9, is made up of multiple capacitive elements 80 connected together. As with most capacitors, there is a common reference interface 82, and an input/output interface 84.

An example of an electrical energy source 140 is a solar voltaic cell, or a group thereof, such as those commonly used in calculators or emergency street-sign lighting, although any electrical energy generating source is appropriate for use in this invention, as is the use of multiple energy generating sources simultaneously.

### Operation—FIG. 1—Additional Embodiment

The EESU 100 is charged with energy from the electrical energy source 140. Transferring charge to an external device (not shown) is accomplished through the external interface 130. Generally, electrical charge is transferred from the EESU 100 through the external interface 130 to another device (not shown). In some cases, users may want to pre-charge the device by transferring electrical charge into the EESU 100 of this apparatus 20 for backup or emergency use storage. To do this, charge is transferred from an external source (not shown) into the EESU 100 of the apparatus through the external interface 130.

An exemplary apparatus 20 of this additional embodiment of the invention is a portable energy collection and storage device to be stored within an aircraft, watercraft, vehicle or other craft for emergency or backup use.

The exemplary apparatus 20 of FIG. 1 consists of a set of solar collector cells potentially covering one side of the portable device as the electrical energy source 140, the energy from the solar collector panels is stored into the EESU 100 within the portable device as the power storage unit, and an external interface on the portable device allows energy from the EESU 100 to be transferred to the craft for use. Optionally, the device can be constructed in such a manner that energy is pre-stored into the EESU 100 of the portable device 20 from an external source (not shown) prior to being stored into the craft. This allows the craft to carry additional electrical energy to power the craft for emergency use or will allow the operating time of the craft to be extended.

For aircraft, watercraft or other crafts that utilize an electric motor FIG. 6 similar to the prior art invention of patent application John B. Miller Ser. No. 12/873,317, should they run out of their usual electrical energy reserves and otherwise be stranded, retrieving the invention from storage and attaching it to the craft as a backup or emergency energy source will allow the craft to continue on its journey, thus being a valuable and potentially life saving invention. The device of this invention can be pre-charged with backup energy, it can generate energy utilizing its own energy generation capability, or both.

An exemplary EESU is a capacitive-based energy storage system based on the Electrical-Energy-Storage Unit (EESU) of Richard Dean Weir U.S. Pat. No. 7,466,536 B1, or a system with similar qualities, designed appropriately as an auxiliary storage device for the particular type of craft.

An exemplary solar collector can be made from XOB17-01x8 solar components from IXYS. A single unit gives a 4.90 Volt typical open circuit voltage output with a 4.2 miliamperes (mA) short circuit current. Utilizing multiple of these solar components in parallel or in series within an apparatus can give larger charge current capability, larger charge voltage capability, or both.

### CONCLUSION, RAMIFICATIONS, AND SCOPE

Thus the reader can see that many useful, convenient and reliable devices can be created for users utilizing the elements of this invention, devices with unique features and operational capabilities that are distinct from prior art devices based on electro-chemical batteries and ultracapacitors.

With this invention, reliable backup or emergency power with renewable energy generation can be made available nearly anywhere to users of vehicles, aircraft and watercraft, as well as to nearly any building or other site that utilizes electric energy.

With the utilization of this electrical energy generating invention on hundreds of thousands of tractor-trailer rigs and other similar devices, hundreds of thousands of megawatts of energy can be generated yearly to reduce dependence on fossil fuel energy usage and to reduce the costs to users for transporting goods across the country and around the world.

Improvements over prior art devices include greatly enhanced reliability due to nearly unlimited recharge capability, the ruggedness over temperature and voltage variations, and an extended shelf life due to the extremely low self-discharge properties of the EESU power storage unit within the apparatus. A device of this invention also has minimal impact on the environment as compared to prior art devices since recharging devices of this invention affords long lasting convenience to the user while requiring little need for the user to change out or discard the EESU power storage unit within the apparatus as with prior art batteries, thus eliminating much waste and pollution being added to the environment. Also, the capability of a device of this invention to be compact due to the EESU having a higher energy density than batteries or ultracapacitors can make many devices portable and convenient, and can therefore make them more useful to users than is possible with prior art devices, especially devices based on prior art capacitors.

Thus the combination of on-board recharging capability with nearly any electrical energy generation source, connectivity to external energy sources and end-user devices, better overall reliability, smaller size, better portability, better durability, reduced waste, reduced pollution, and better user convenience are the features that make a device of this invention unique as compared to prior art devices.

While the above description contains many specificities, these should not be construed as limitations on the scope of the invention, but rather as an exemplification of preferred embodiments thereof. Many other variations are possible.

For example, the capacitive, ceramic-based electrical energy storage unit (EESU) need not be limited to the EESU of Richard Dean Weir, U.S. Pat. No. 7,466,536 B1. Other ceramic-based electrical energy storage unit of various make-ups with various storage capacities, unit sizes, operating voltages and other features may be utilized in this invention.

This invention can be attached to nearly any electrical or electronic device with appropriate external connectivity, not just those that utilize the prior art invention of patent application John B. Miller Ser. No. 12/873,317.

The on-board electrical energy source is not limited to a solar collector based on the XOB17-01x8 solar components from IXYS. Any solar components, or group of solar components, will fulfill the requirements of this element of this invention. Also, energy generation on devices of this invention is not limited to solar devices, but can come from any electrical energy generation source including solar, wind, acoustic, static, electro-mechanical including electric motor feedback, man-powered, thermal, water-powered, as well as an electric generator powered by an internal combustion engine or nuclear energy, and others.

An external interface can consist of an electronic component or circuit, a switching mechanism, a simple mechanical interface, or other interfaces. It can include an on/off switching mechanism, voltage conversion circuitry, charge transfer capability, charge control circuitry, or other, or a combination thereof.

Thus the scope of the invention should be determined by the appended claims and their legal equivalents, rather than by the examples given.

I claim:

1. An apparatus, comprising:
a capacitive ceramic-based electrical energy storage unit (EESU),
an electrical energy source, and
an external interface,
wherein said EESU is coupled to said electrical energy source and said external interface.

2. The EESU of claim 1 wherein components of said EESU are manufactured with the use of ceramic fabrication techniques.

3. The EESU of claim 1 wherein multiple energy storage components of said EESU are arranged in a parallel configuration.

4. The EESU of claim 1 wherein said components of said EESU are manufactured using barium titanate.

5. The external interface to said EESU of claim 1 wherein said interface includes voltage conversion circuitry.

6. The external interface to said EESU of claim 1 wherein said interface includes charge transfer control circuitry.

7. The electrical energy source of claim 1 wherein said electrical energy source includes solar powered electrical energy generation.

8. The electrical energy source of claim 1 wherein said electrical energy source includes wind powered electrical energy generation.

9. The electrical energy source of claim 1 wherein said electrical energy source includes electro-mechanical powered electrical energy generation including electric motor feedback.

10. The electrical energy source of claim 1 wherein said electrical energy source includes man-powered electrical energy generation.

11. The electrical energy source of claim 1 wherein said electrical energy source includes electrical energy generation driven by an internal combustion engine.

12. The electrical energy source of claim 1 wherein said electrical energy source includes water or rain powered electrical energy generation.

13. An apparatus, comprising:
a means for generating electrical energy,
a capacitive ceramic-based electrical energy storage unit (EESU), and
an external interface,
wherein said EESU is coupled to said means for generating electrical energy and said external interface.

14. In an apparatus, a method of generating, storing, and transferring electrical energy comprising:
generating electrical energy in an electrical energy source,
storing electrical energy from said electrical energy source into a capacitive ceramic-based electrical energy storage unit (EESU), and
transferring electrical energy between said EESU and an external interface.

15. The EESU of claim 14 wherein components of said EESU are manufactured with the use of ceramic fabrication techniques.

16. The external interface to said EESU of claim 14 wherein said interface includes voltage conversion circuitry.

17. The external interface to said EESU of claim 14 wherein said interface includes charge transfer control circuitry.

18. The electrical energy source of claim 14 wherein said electrical energy source includes solar powered electrical energy generation.

19. The electrical energy source of claim 14 wherein said electrical energy source includes wind powered electrical energy generation.

20. The electrical energy source of claim 14 wherein said electrical energy source includes electrical energy generation driven by an internal combustion engine.
